(19) United States
(12) Patent Application Publication
(10) Pub. No.: US 2017/0093619 A1
(43) Pub. Date: Mar. 30, 2017

(54) DISTRIBUTED INTERNET CRAWLER, CONNECTOR, AND INFORMATION PUBLISHER AND METHOD OF USE

(71) Applicant: Detong Chen, Grand Forks, ND (US)

(72) Inventor: Detong Chen, Grand Forks, ND (US)

(21) Appl. No.: 14/983,499

(22) Filed: Dec. 29, 2015

Related U.S. Application Data
(63) Continuation-in-part of application No. 14/865,281, filed on Sep. 25, 2015.

(51) Int. Cl. H04L 12/24; G06F 17/30; H04L 29/08

(52) U.S. Cl. CPC H04L 41/0803; H04L 67/02; H04L 67/26; H04L 67/12; G06F 17/30289; G06F 17/30864

(57) ABSTRACT

A distributed search and database system for the “Internet of Things” is described, comprising a distributed Internet crawler for grabbing and managing information of objects or “things” in an area and servers, a special distributed internet connector for creating interconnections between the “things” in an area and the system, and an information publisher for supporting the creation and updating of information by the administrator or the system.

### CROSS REFERENCE TO RELATED APPLICATIONS

This application is a continuation-in-part of and claims the benefit of U.S. patent application Ser. No. 14/865,281, filed Sep. 25, 2015, entitled “FLEXIBLE DESTINATION SETTING AND ROUTE INDICATION SYSTEM” which is incorporated herein by reference.

### FIELD OF INVENTION

This invention relates to systems for collecting data from a distributed network and downloaded the rest partial data from the servers, and specifically to a system used for gathering information from the objects in a defined area, downloading corresponding information from severs and providing a searchable database of information on those objects to one or more users.

### BACKGROUND

With the continuous development of society, the physical world becomes increasingly complex and varied, and the amount of data generated is growing exponentially. When people visit an area (either an actual, physical visit or a virtual visit via the Internet), it is difficult for them to quickly comprehend the area and to find what they want. Also, the administrators of the area do not know the user's needs, and so it is difficult to make appropriate adjustments to meet the needs of users. Overall, the information contained or represented by a geographical area, is fairly opaque, and an area's environment is not conducive to quickly providing both information on the area in general and more specific information on the objects contained in that area. The networked devices do not work consistently and may not satisfy human's advanced needs.

What is needed in the art is system combining a novel distributed internet crawler capable of grabbing information from objects in an area, along with related information form servers, using this information to create a searchable database, and publishing the information for the use of users and other systems, creating a special interconnection between the objects and systems in the area.

### SUMMARY OF THE INVENTION

The general concept of the present invention is outlined as follows:

Distribute a number of device nodes into an area and let them link to a host computer to establish a wireless network of nodes (a wireless local area network, or WLAN). Then, use special terminal software in the host computer to configure the system. After that, the system will be ready for large-scale local information grabbing, downloading, indexing, editing, searching, interacting, etc.

Users in the area can use portable electronic devices (including, but not limited to, cell phones, mobile computers, and Internet-capable eyeglasses) to connect to the system to do a search, and then view the information on the objects in this area.

The administrator of the area can index and edit the information of the physical world's things in this system's database by using a designed client application which is installed on a portable electrical device that can connect to the system via the internet.

The manufacturers of products provide interfaces that can be accessed and controlled via the network (via the device nodes in the system), when new products are connected to or detected by the wireless local area network.

The manufacturers of products can proactively push updated information (such as temperature changing) on products to the device nodes to be stored and used in the system via the WLAN.

Each device node in the system contains rules defining their behavior when certain defined “events” related to objects in the area they cover occur. These rules define the overall behavior of the system and allow the system to pass information related to these events to other systems and users.

Remote servers connected to the system network collect information from each device node in different areas for trans-regional information grabbing, indexing, searching, interacting, and for analyzing the interconnections between the objects (or “things”) to establish better rules for the system to download and for people to use.

The manufacturers of products can upload related information of their products to the servers which can be download by different systems distributed in different areas when their products connect to the system for the first time.

According to one aspect of the present invention, a distributed internet crawler, connector, and information publisher is described which is a combination of a distributed internet crawler for the “internet of things” (grabbing information from objects or “things” in the area and servers, making a copy to its own database and indexing for users to search and view across areas), a special distributed internet connector for the “internet of things” (creating interconnections between everything in the area and the system) and an information publisher for the “internet of things” (supporting the creation and updating of information by the administrator manually or the system automatically).

This aspect and others are achieved by the present invention, which is described in detail in the following specification and accompanying drawings which form a part hereof.

### BRIEF DESCRIPTION OF DRAWINGS

FIG. 1 shows an example of a typical wireless ad-hoc network (WANET) of the prior art.

FIG. 2 illustrates a portable device interacting with a WLAN of the prior art.

FIG. 3 shows one possible arrangement of nodes and “things” in the system of the present invention.

FIG. 4 is a flowchart illustrating one embodiment of an algorithm for calculating the distance from one device node to the other device nodes in a WANET.

FIG. 4B provides an illustration of how the nodes of the present invention may be set up in a physical location.

FIG. 5 shows an example terminal software screen, used for configuring the nodes in the system of the present invention.

FIG. 6 is an illustration of one embodiment of a device node in the system of the present invention.

FIG. 7 is an illustration showing one possible placement of a device node of the present invention in a typical room or hallway.

FIG. 8 is a functional block diagram of one embodiment of a device node from the system of the present invention.

FIG. 9 shows a map of one possible arrangement of device nodes in a building.

FIG. 10 illustrates the actual communication routes between the device nodes of the arrangement of nodes shown in FIG. 9, as they would appear in an ad hoc network.

FIG. 11 illustrates the communication routes between the device nodes of the arrangement of nodes shown in FIG. 9, as they would appear when using a geographical neighbor's scheme.

FIG. 12 illustrates how network nodes communicating with neighbor nodes can determine and report exceptions.

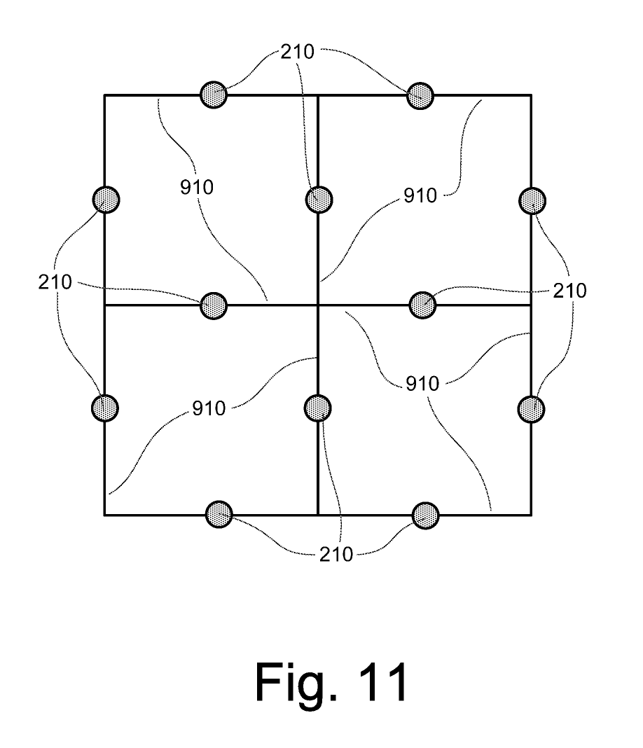

FIG. 11 is an illustration of how route generation can occur in one embodiment of the system of the present invention.

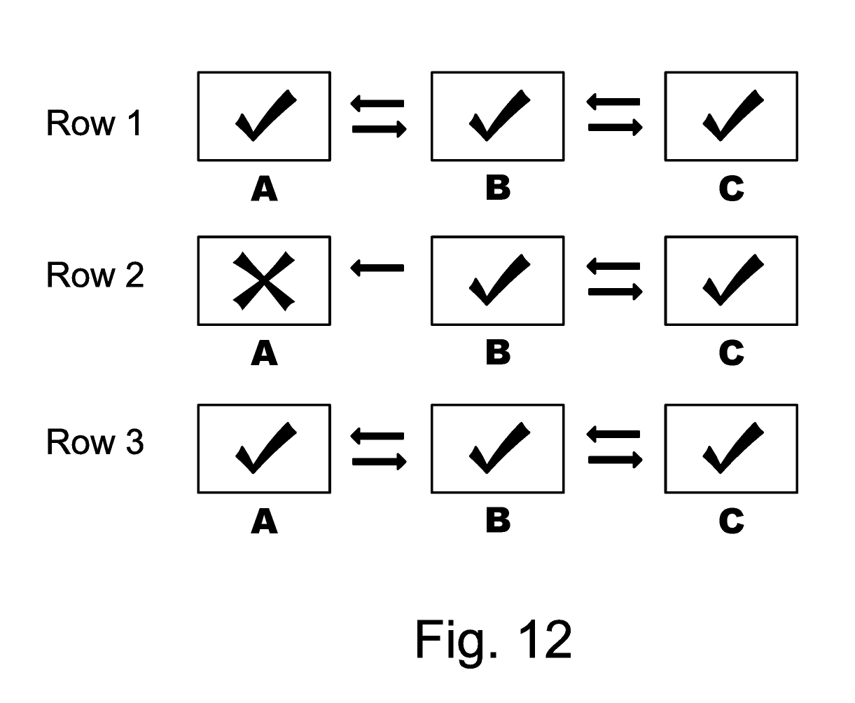

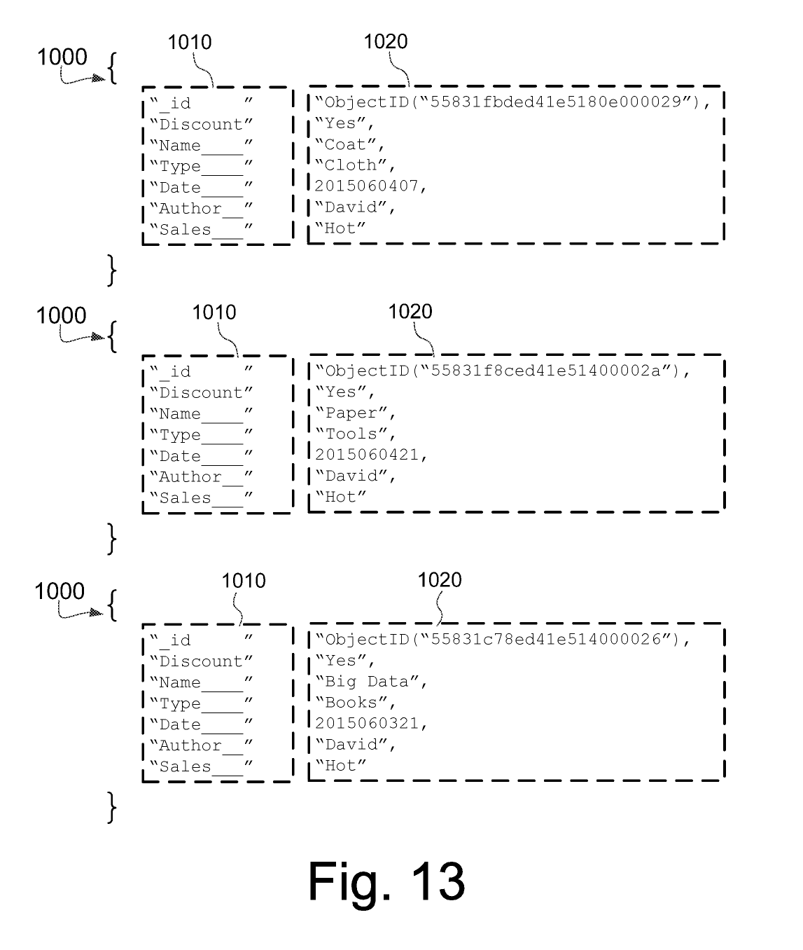

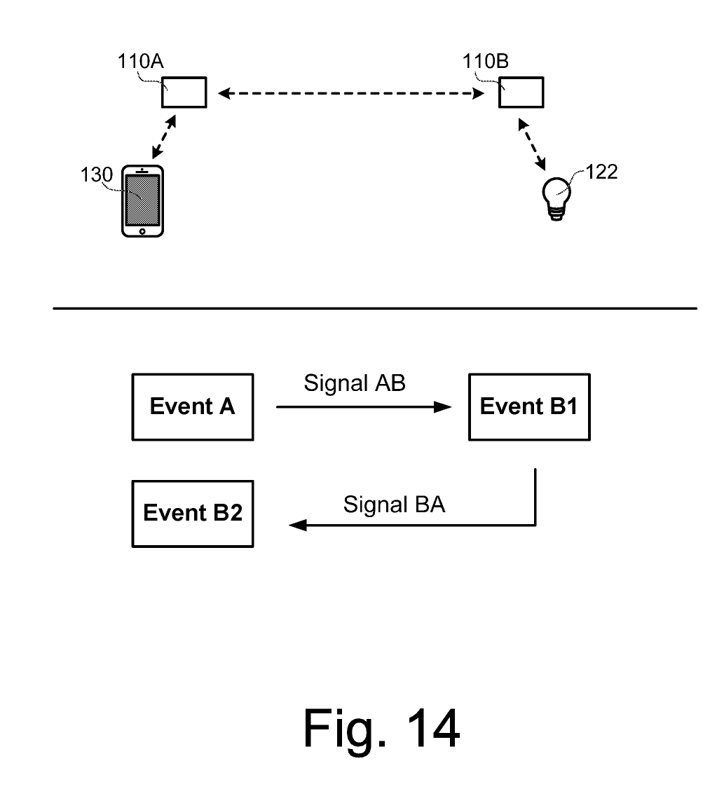

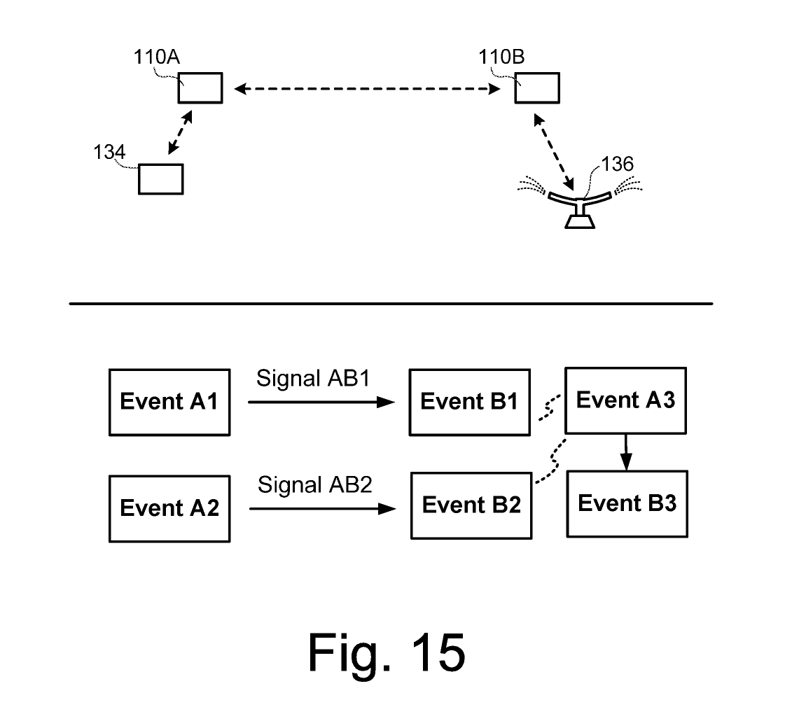

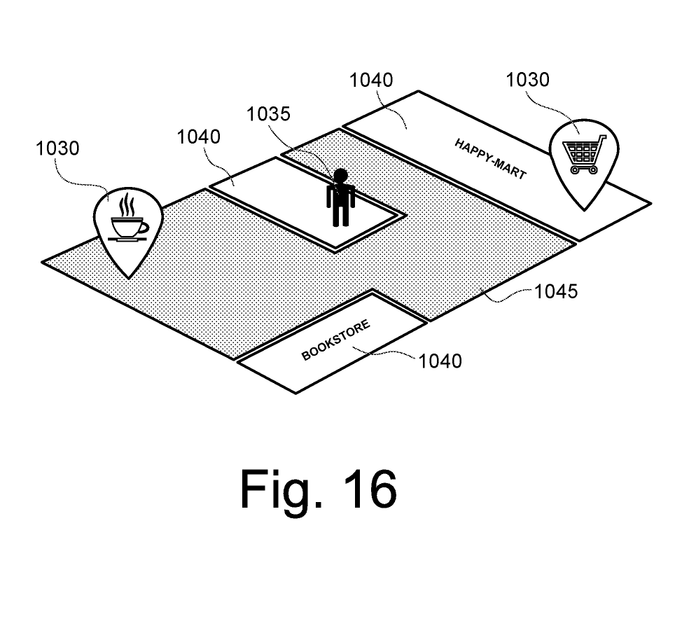

FIG. 12 is a flowchart capturing one embodiment of an algorithm that may be used with the system of the present invention.

FIG. 13 provides examples of possible data constructs which could be read by the RFID reader of the present invention.

FIG. 14 is an illustration of an example of system use, where a light is controlled from a mobile device from a separate room.

FIG. 15 is an illustration of an example of system use, where a sprinkler system can be controlled based on sensors located at a remote (separate) location.

FIG. 16 illustrates one embodiment of a map that could appear on a user's portable device to show the user's location in relation to other things in the system.

### DETAILED DESCRIPTION OF THE PREFERRED EMBODIMENT

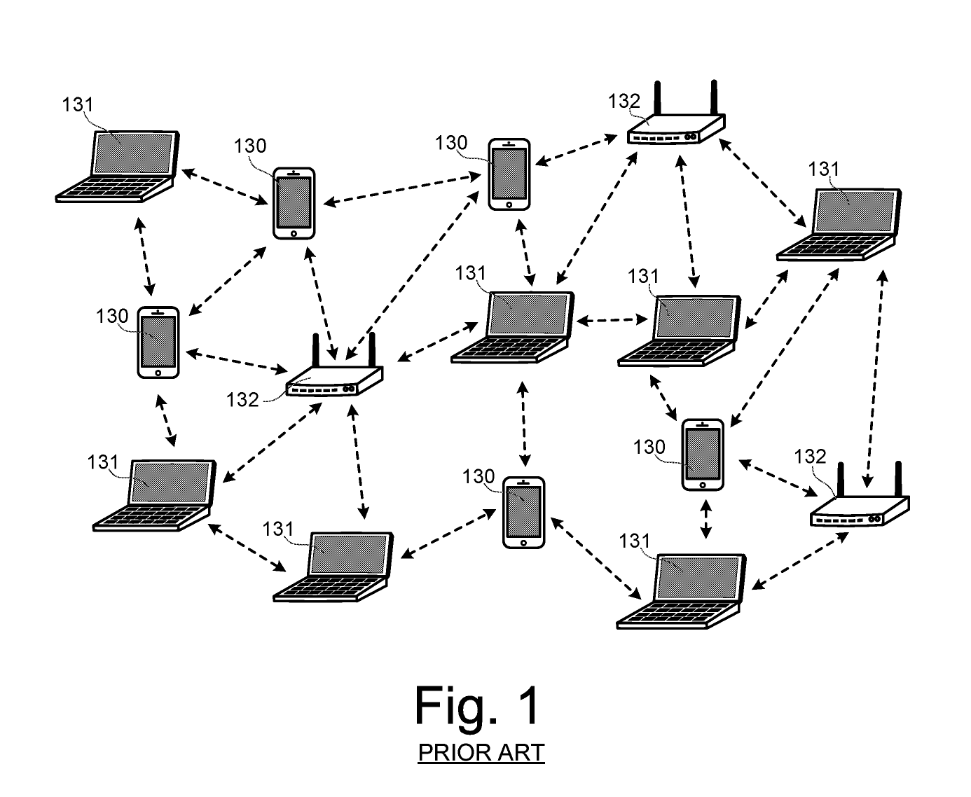

With reference now to the drawings, and in particular to FIGS. 1 through 16 thereof, a new distributed internet crawler, connector, and information publisher and method of use will be described.

References in the specification to “one embodiment”, “an embodiment”, “an example”, “another embodiment”, “a further embodiment”, “another further embodiment,” and the like, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In this document, the terms “network node” and “device node” will be considered to be synonymous, and any description given for one of the terms shall apply to the other term.

Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The “Internet of Things”, or IoT, is a term used to refer to the network of physical objects or “things” which are embedded with electronics, software, sensors, and/or network connectivity, enabling the objects to collect and exchange data with each other and with other systems, including the Internet and devices connected to the Internet. IoT allows objects to be sensed and “read” and controlled remotely across existing network infrastructure. This creates opportunities for direct integration between the physical world and computer-based systems, giving opportunities for improved efficiency, accuracy, and economic benefit.

“Things,” in the IoT sense, can refer to a wide variety of devices such as medical implants, biochip transponders, intelligent vehicles, including roadways with built-in sensors, and even consumer goods embedded with devices such as RFID chips, exchanging information with special readers or sensors. These devices collect useful data with the help of various technologies, and then autonomously send the data to other devices.

The present invention is a system designed to work with and expand the limits and boundaries of the Internet of Things. The remaining portions of the specification will describe the present invention, a distributed internet crawler, connector, and information publisher and method of use, in additional detail.

Specifics of the System

The present invention has two primary options for architecture, using a centralized architecture or a distributed architecture.

In the centralized architecture embodiment, terminal software in the host computer is responsible for managing everything, including maintaining and managing a centralized database and a knowledge engine (for executing the system and node-specific rules). All the device nodes are controlled by the central host computer.

The advantage of such a centralized architecture is a lower cost for each device node, and the disadvantages are higher cost on the host computer and the dependence on a single computer, which could provide a single source of failure.

In the distributed architecture embodiment, each device node is a center for managing everything in the area it covers. A partial database and knowledge engine (rules executor) is running in each device node, such that the entire database is spread out among all the nodes. The device nodes are connected by the wireless local area network, and work in parallel.

The advantages of the distributed system are a lower cost for the host computer and the removal of the single point failure inherent in the centralized database. The disadvantage of the distributed system architecture is a relatively high cost for each device node.

The present invention has two ways to let users connect their portable devices, via the internet though the host computer, or via the WLAN through the nearest device node.

Via the Internet Through the Host Computer:

In the centralized architecture, portable devices directly communicate with the host computer. In the distributed architecture, the host computer become a medium (router) and establishes a connection between the portable device and the device node picked by the user.

Via the WLAN Through the Nearest Device Node:

In the centralized architecture, the device node nearest the portable device will establish a connection between the portable device and the host computer. In the distributed architecture, the portable device communicates directly with the nearest device node.

One embodiment of the present invention comprises six components:

Host computer, including terminal control software:
Used to configure each device node, including setting its geographic position information and neighbor relationship.
Submits data to the remote servers (via the Internet) for other uses, supports users visiting online.
Downloads related information of Objects (such as connected device) from the servers.
Connects to portable devices via the internet.
Pushes a regional map to portable electronic devices for identifying locations. Automatically updates the regional map.
Can be a medium (router) for establishing a connection between the Internet and any device node in this system (distributed architecture).
Maintains a database for storing each device node's collected information, for supporting high-performance information indexing, for keyword searching, and for the identification and location of specific things (centralized architecture).

Wireless device node, including device node software:
All device nodes can uniformly establish at least one WLAN (wireless local area network) depends on the demands, and one WANET (wireless ad-hoc network).
Each device node can communicate with other device nodes via the WANET.
Each device node is an “entrance” for external things (devices such as lights, air conditioner, clock, and RFID reader) to dynamically access the WLAN (devices can join and leave) and receive information from external things.
Each device is an “entrance” for portable electronic devices (such as cell phone, iPad, etc.) to dynamically access the WLAN (devices can join and leave), and interact with the portable devices.
Each device node can push a regional map to portable electronic devices which have not downloaded the map yet via the WLAN. The regional map shows the location of “things” and helps the user to navigate to the desired location. The regional map will be updated automatically when significant changes/updates occur.
Each device node can send the information it grabs (information read from the sensors and other components of the IoT) to the host computer.
Each device node maintains a partial database for supporting high-performance information indexing, data storage, keyword searching, and the location of specific “things” (distributed architecture).

Portable Electronic Devices, including a specific Application:
Portable electronic devices can connect to the system by either joining the WLAN through the nearest device node or connecting via the internet through the host computer to interact with this system.
After connecting to the system, the application can show a search bar, tabs for viewing recent search results, search history, or saved bookmarks (similar to website browsers).
The searching and viewing results (includes information specific to “things” searched for, information describing the current device node and the connection) can be displayed on the application.
The application can calculate the routes based on the information in the regional map, as well as the information of the selected device note (that is, the device node that is either the entrance used by “things” to join the WLAN or selected specifically by users to guide a user to the place they want to visit).

Administrator's electronic device (cell phones, pads, computers, and any electrical devices which has privilege to visit the database), including a special client application.
This system has at least one account verification to prevent illegal access to the system database, so the administrator needs to use a client application with correct account credentials to access the databases either via the WLAN through nearest device node or via the internet through the host computer. Once the database has been accessed, the administrator can use the device to do actions, such as viewing a “thing's” information, deleting a “thing's” information, adding or modifying a “thing's” information, and so on (that is, manually maintaining the database).

5. External Things in the Real World
Specially designed RFID reader (for reading the information from things equipped with RFID chips or similar passive or active devices) which can join the WLAN via the nearest device node.
Smart device equipped with a wireless communication module which can join the WLAN via the nearest device node.
Small sensors equipped with wireless communication modules which can join the WLAN via the nearest device node.

Remote Servers:
A cluster of computers that collects information from each of the different geographical areas in the overall system for realizing transregional (across different regions) information grabbing, transregional information indexing, transregional information searching, transregional information visiting, and transregional information interacting.
A cluster of computers that supports the information of the products uploading and storing from their manufacturers.
A cluster of computers that supports the information of the products downloading by different systems that may be distributed in different areas when unknown products (devices) connect to the system for the first time

One core concept of this solution is the wireless network. The device nodes in the wireless network needs to be able to automatically constitute a WANET (wireless ad-hoc network) for internal communication which only allows device nodes can join.

Wireless ad-hoc networks, or WANETs, exist today. FIG. 1 shows the basics of a typical WANET of the prior art. The WANET consists of computers 131, personal devices 130, and wireless routers 132, each of these devices connected to every other, either through a direct wireless connection (shown as dashed, bi-directional arrows between devices) or by being routed through other devices.

A wireless ad hoc network (WANET) is a decentralized wireless network. It is considered “ad hoc” because it does not rely on pre-existing infrastructure, such as routers in wired networks or access points in managed (infrastructure) wireless networks. Each node participates in routing by forwarding data for other nodes, so the determination of which nodes forward data is made dynamically on the basis of network connectivity. In addition to the classic routing, ad hoc networks can use “flooding” for forwarding data. Flooding is a computer network routing algorithm in which every incoming packet is sent through every outgoing link except the one it arrived on.

Wireless networks lack the complexities of infrastructure setup and administration, enabling devices to create and join networks “on the fly.” Once the ad-hoc network is established, each device node can perform the following operations.
Broadcast: A device node can send a message to all device nodes in the network.
P2P (point to point): a device node can send a message to the specified device node in the network.

Device nodes in the system can establish at least one WLAN (wireless local area network) for external smart devices (such as RFID readers, lights, clock, and any smart devices which support network connections) and portable devices (cell phones, iPad, laptop, etc.) to join dynamically.

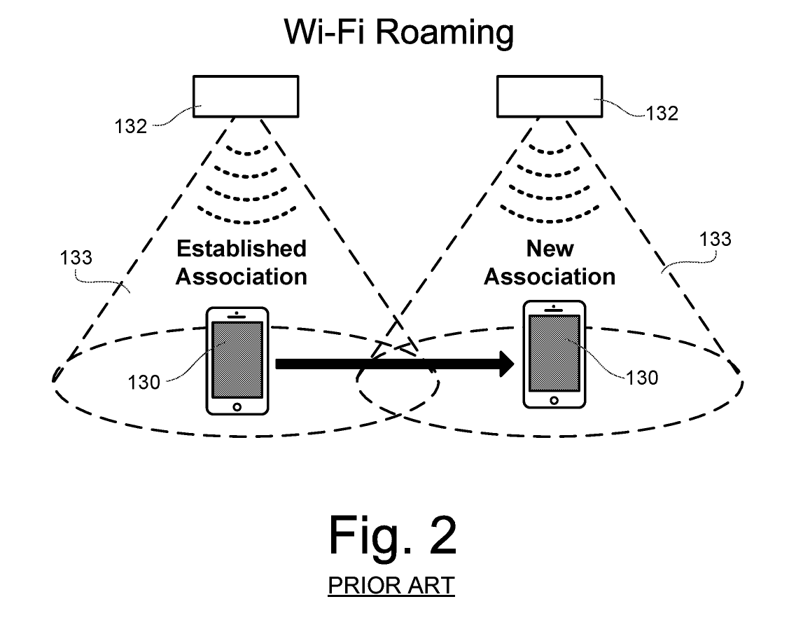

FIG. 2 illustrates a portable device interacting with a WLAN of the prior art. The diagram shows the principle of a WLAN, that a portable device 130 will keep connecting to the nearest wireless router 132 (or a device node) without disconnecting from the network. Each wireless router 132 emits a field 133 of wireless signals. When the wireless routers 132 are placed such that these fields 133 overlap at least slightly, the portable device 130 will transition smoothly from one field 133 to the next without losing connection from the network.

At present, the primary wireless communication technologies which can satisfy the requirements of WANET for device nodes' intercommunication are Wi-Fi, Bluetooth and ZigBee. (If the device nodes communicate with each other frequently and heavily, ZigBee is not recommended due to its low ratio speed).

Network Arrangement of the Present Invention:

Firstly, distribute and install enough device nodes in the environment depending on the requirement. Then, supply enough electricity for maintaining them running. After that, configure each device node's wireless communication module to an appropriate transmitting power. Because of the characteristics of WANET, device nodes will form a distributed network automatically, also, a new device node will join this distributed network automatically.

2. Select at least one device node and connected it to the host computer by wires, and treat it as terminal device node (the host computer communicates with this terminal device node via wires).

3. Open the terminal software on the host computer, administrator configure parameters for each device node depending on real situation. Subsequently, the terminal software running on the host computer will send all configuration parameters for all the device nodes to all of the terminal device nodes, all the terminal devices node will route each specific configuration parameters in the entire configuration parameters to the related device node via peer-to-peer (P2P) connection. Each device node (including the terminal device nodes) receiving the specific parameters will process the parameters received and a success message will be sent back to the terminal device node. The terminal device node will route all the message which come from any device node to the host computer.

After each device node's configuration is completed, all the device node will uniformly establish at least one WLAN for users' portable devices and external things to join dynamically.

Finally, the system is running in the normal operating mode and supporting following functions.
All the data (such as users' interaction history and the information grabbing from external things) that device nodes collected are sent to terminal device nodes, then terminal device nodes directly transfer these data to the host computer via wires without any analysis and use.
Users can let their own portable electronic devices either join the WLAN through the most adjacent device node or connect via the internet through the host computer, and then use specific application to achieve regional map and do other interactive operations (searching, viewing and so on).
Administrator can use electronic device to either join the WLAN through the most adjacent device node or connect via the internet through the host computer, and then use specific application to access the database with a valid account to do some actions, such as viewing stuffs' information, deleting stuffs' information, add stuff's information, updating stuff's information and so on. (Manually maintain the database).
External things can join the WLAN through the most adjacent device node, and the system can create, download (from servers) and update their information that stores in the database depending on their responses.
Via the internet (Host computer connects to the internet), system can submit the data collect to the remote service, and user can do interactive operations remotely (visit online).

In order to relieve the wireless communication congestion (To avoid all device nodes send collected data to only one terminal device node which is directly connected to the host computer which will cause wireless communication congestion, we can define several terminal device nodes in different areas, letting different areas' device node send collected data to the related terminal device node to shunt data.)

Possible Arrangement of the Present Invention:

To create the distributed internet crawler, connector, and information publisher system (hereinafter, the phrase “distributed internet crawler system” shall be considered an abbreviated version of, and synonymous with, the phrase “a distributed internet crawler, connector, and information publisher system”), a sufficient number of device nodes are installed to adequately cover the desired area. After the nodes are installed and provided with adequate power to perform, the wireless communication module for each device node is configured (that is, set to an appropriate transmitting power, set to communicate as part of the ad-hoc network, etc.) Because of the characteristics of an ad-hoc network, the device nodes will form a distributed network automatically, and any new nodes introduced to the network will be added automatically.

At least one device node will be connected to the host computer by a direct wired connection. This device node will serve as a terminal device node (the host computer communicates with this terminal device node directly via the wired connection). There may be more than one terminal device node.

Once the device nodes are thus installed, an operator opens the terminal software on the host computer and configures parameters for each device node depending on the node's location, geographic relationship, communication address, and the communication address of the appropriate terminal network node. Subsequently, the software running on the host computer will send all configuration parameters for all the nodes to all of the terminal device nodes, all the terminal devices node will route specific configuration parameters to the related device node via peer-to-peer (P2P) connection. Each device node (including the terminal device nodes) receiving the specific parameters will process the parameters and a success message will be sent back to the terminal device node. The terminal device node will route all the messages which come from any device node to the host computer.

In order to relieve wireless communication congestion, multiple terminal device nodes could be provided at different points in the network to help relieve communication congestion.

After each device node's configuration is completed, all the device nodes will uniformly establish at least one WLAN for portable devices and external “things” to join dynamically. Once this is completed, the network is operation in the normal operating mode. In normal operating mode in the present invention:
All the data the device nodes collected (such as a user's interaction history and the information grabbing from external things) are sent to the terminal device nodes, then the terminal device nodes directly transfer this data to the host computer via wires without any analysis or use.
Users can let their own portable electronic devices join the WLAN through the most adjacent device node, or connect via the internet through the host computer, and then use specific applications to update and open the regional map and do other interactive operations (searching, viewing, etc.)
The administrator can use a portable electronic device to either join the WLAN through the most adjacent device node or connect via the internet through the host computer, and then use specific applications to access the database with a valid account to perform actions, such as viewing information gathered on a “thing”, adding, deleting, or updating a thing's information and so on. (That is, to manually maintain the database).
External things can join the WLAN through the most adjacent device node, and the system can create, download (from servers) and update their information that stores in the database depending on their responses.
The system can submit the data collected to a remote service (host computer is connected to the Internet), and the users can do interactive operations remotely (that is, visit online).

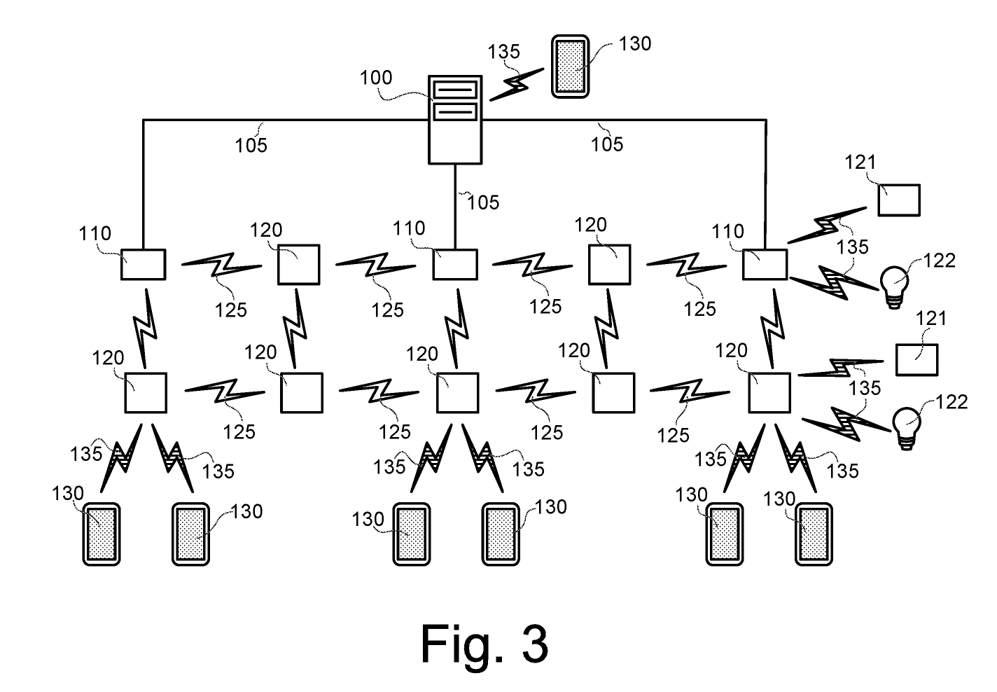

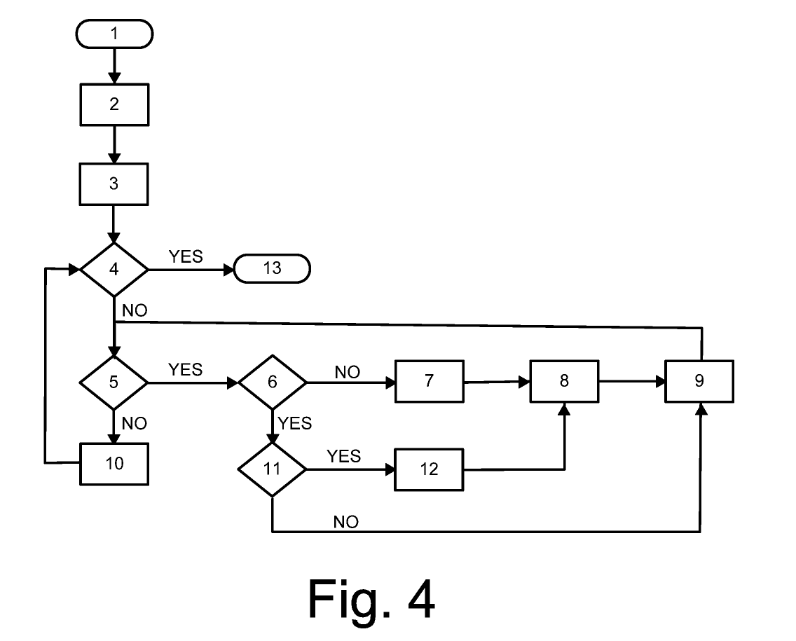

Turning now to FIG. 3, we see one possible arrangement of nodes in the system of the present invention. A host computer 100 is attached to the network and used for initial configuration of the network, but is thereafter not needed for the operation of the network during normal operation. The network itself consists of terminal network nodes 110 and non-terminal nodes 120. A network node, sometimes referred to as a device node) comprises a module capable of wireless communications 125 and peripheral equipment (if appropriate).

A terminal network node 110 is a network node that is connected directly to the host computer 100 via a hard-wired connection 105.

A non-terminal network node 120 is a network node that does not have a direct hard-wired connection to the host computer 100.

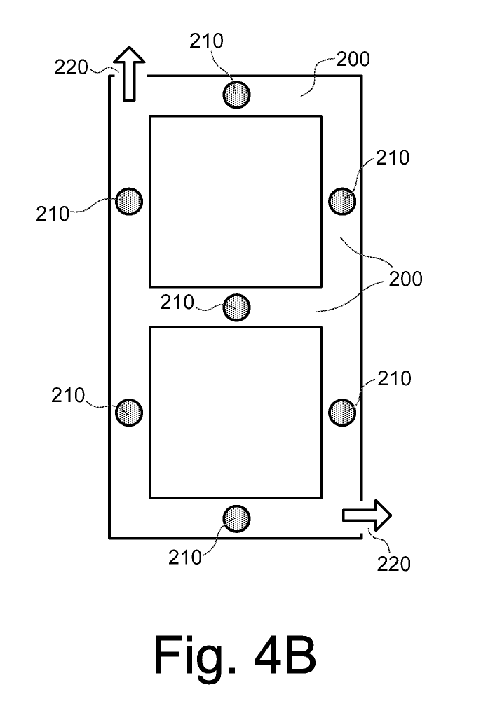

Beginning in FIG. 4B, the reference designator 210 will be used to refer generically and collectively to both terminal network nodes 110 and non-terminal network nodes 120, whenever making a distinction between the two is not important to the discussion.

The network of the present invention comprises both terminal network nodes 110 and non-terminal network nodes 120, all of which are connected via a wireless communications protocol 125 as previously described. Each node in the network is capable of communicating via a wireless protocol 135 to any number of portable electronic devices 130. The host computer 100 is also capable of communicating to a portable electronic device 130 (as well as a variety of other electronic systems, not shown) via a wireless protocol 135.

The wireless protocol 125 used between network nodes may or may not be a different protocol than the wireless protocol 135 between a network node 110/120 and a user's portable electronic device 130. In one embodiment, wireless protocol 125 may be ZigBee communication, and wireless protocol 135 may be Bluetooth communication. In another embodiments, both wireless protocols 125 and 135 may be Bluetooth communication. However, any appropriate wireless communications protocol or standard may be used for either or both wireless protocols 125 and 135.

The network nodes 100 and 120 are capable of communicating with external “things” such as sensors 121 or devices 122 such as lights, RFID readers, etc.

The host computer 100 will satisfy the following requirements:
It must connect to at least one network node (terminal network node 110) via a hard-wired connection 105.
It must execute the terminal software.
It must connect to the Internet.

Regional Map Generating

The software running on the host computer 100, that is, the terminal software, will satisfy the following requirements to generate a regional map:
The terminal software must allow an administrator to set the geographic position of each network node 110/120. In one embodiment, this may be done by first defining an origin in order to establish a Cartesian coordinate system, set the node's position in the coordinate system, such as X=150 Y=200 Z=900.
Using the network node's unique ID, an administrator can configure the terminal network node unique ID that is saved inside the network node.
Using the network node's unique ID, an administrator can configure a list of relationships between network nodes (whether they are geographical neighbors or not, how far apart they are, etc.) Direction can be calculated by an algorithm depending on location, in order to achieve P2P (a network node can send a message to the specified network node) via WANET.
Based on the above determined information, an administrator can generate a distribution diagram for verifying and comparing.
When all the configuration is completed, the terminal software will calculate all the distances from the current network node to the rest of the network nodes. This is done for each network node, and all the parameters are sent to one terminal network node which connects to the host computer via a hard-wired connection. Subsequently, this terminal network node will separate these data parameters into groups and send each group to corresponding network node.
When a network node receives parameters (including terminal network node), it needs to deal with these parameters and send a response back. This process might take a while due to the number of parameters and size of the WANET.

The following describes what will be included in the parameters that will be sent to the terminal network node, which will in turn be routed to each of the other network nodes?

[For Centralized Architecture]
1. The communication address of the terminal network node.
2. The regional map.
3. The communication address of each network node's geographic neighbor.

[For Distributed Architecture]
1. The communication address of the terminal device node.
2. The regional map.
3. All the distances between each network node. (The communication address of all network nodes will be included).
4. The communication address of each network node's geographic neighbors.

FIG. 4 is a flowchart illustrating one embodiment of an algorithm for calculating the distance from one device node to the rest of the device nodes in a WLAN. There are many mature algorithms for calculating the distances from one network/device node to the other network/device nodes. FIG. 4 shows one embodiment of an improved algorithm which is similar to Dijkstra algorithm. The following section explains the algorithm in FIG. 4, making reference to the numbered shapes on the flowchart.
1. Start.
2. Establish two lists, list A (for temporary saving) and list B (for saving results).
3. Add original device node into list A (the smaller the index, the earlier added).
4. Is List A empty?
5. The nth neighbor of the first element (earlier added) in the List A exists (n starts from 0).
6. The nth neighbor of the first element in the List A is existed in the list B.
7. Add the nth neighbor of the first element in the List A into list B, including its distance information (where distance=distance between the first element in the list A and the original device node (this information can be found in List B)+distance between the nth neighbor of the first element in the List A and the first element in the list A.)
8. Add the nth neighbor of the first element in the List A into list A
9. n=n+1 (for going to the next neighbor)
10. Remove the first element in the list A
11. The saved distance information of the nth neighbor of the first element in the list B is longer than the new distance information of the nth neighbor of the first element (where distance=distance between the first element in the list A and the original device node (this information can be found in List B)+distance between the nth neighbor of the first element in the List A and the first element in the list A).
12. Update the distance information of the nth neighbor of the first element in the list B.
13. End.

After the above algorithm is executed, all the shortest distances between one network node and the other network nodes is recorded in list B. Using this algorithm to calculate the distance between each network node and all other nodes.

FIG. 4B provides an illustration of how the nodes of the present invention may be set up in a physical location to be monitored. The figure shows a configuration of hallways 200 with network nodes, with exits 220. Installed at strategic locations in the hallways 200 are network nodes 210.

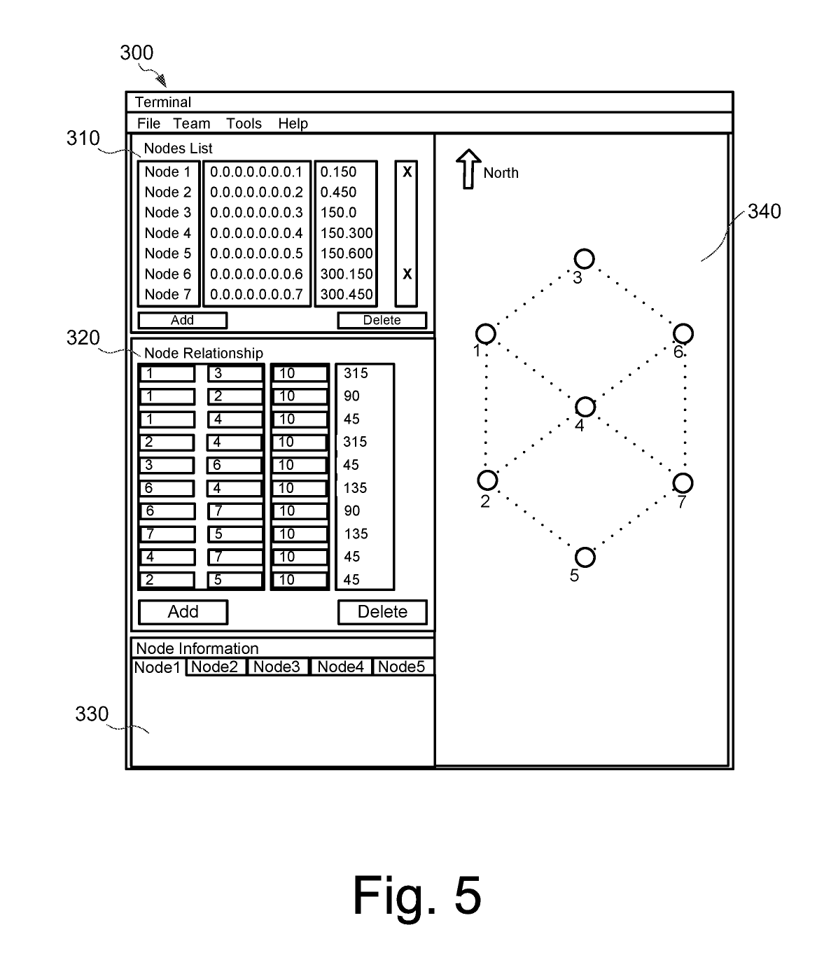

FIG. 5 shows an example terminal software screen, used for configuring the nodes in the system of the present invention. The figure shows an example terminal software screen 300, used for configuring the nodes in the system of the present invention. In this embodiment, the terminal software screen 300 contains a nodes list 310, a node relationship block 320, a node information block 330, and a configuration diagram block 340.

The nodes list 310 is an area where the operator can define information for each network node, including, but not limited to, a unique address for each node, a physical location for each node, an indication whether the node is a terminal node.

The node relationship block 320 allows the operator define the relationship between the nodes in the network, including, but not limited to, whether or not they are geographical neighbors, entering the physical distance between nodes 210, and the angular position of each node to other nodes will be automatically calculated based on the physical location for each node. Two nodes are geographical neighbors if a person can walk from one node to the other without passing other nodes.

The node information block 330 on the terminal software screen 300 displays the collected data gathered from each network node in the network as seen by a terminal device node.

The configuration diagram block 340 displays the configuration graphically for the operator, such that they can verify the configuration of geographical neighbors they are performing. The configuration diagram block 340 is essentially a map of network nodes. Dotted lines are shown in this example to show which nodes 210 are defined as geographic neighbors.

Data Collecting and Submitting

[For Centralized Architecture]

After the above procedure, each network node will run in normal operation mode. Meanwhile, the terminal software can get the data (from terminal network node) that each network node has collected and sends it to the terminal network node to be saved into its database (terminal software manages a local database). Also, the terminal software submits all the data to remote servers for other uses via the Internet.

[For Distributed Architecture]

After the above procedure, each network node will run in normal operation mode. Meanwhile, the terminal software can get the data (from terminal network node) that each network node has collected and sends it to the terminal network node. Also, the terminal software submits all the data to remote servers for other uses via the Internet.

Supporting Online Visits Via the Internet

[For Centralized Architecture]

Since the host computer in this solution connects to the Internet, users and administrators can interact with this system remotely, visiting and editing its local database (activities such as searching information, indexing information, viewing information, and updating information), when people know the IP address of this host computer and connect to it.

[For Distributed Architecture]

Since the host computer in this solution connects to the Internet, and the host computer can be a router that establishes a connection between the Internet and any network node in the system, users and administrators can interact with this system remotely, visiting and editing the database which is distributed in each network node, searching information, indexing information, viewing information and updating information, when people know the IP address of this host computer and connect to it.

Interconnections Between Everything

The terminal software in the host computer can download rules packages from remote servers or get some rules packages from administrators.

[For Centralized Architecture]

Terminal software can apply these rules packages to realize the interconnection between things.

[For Distributed Architecture]

Terminal software send rules packages to related network nodes and let related network nodes apply these rules themselves.

Wireless Network Node+Network Node Program

Device node has many functions, specifically, these functions can be divided into several categories:
[1] Able to exchange data between geographical neighbors for neighbors' error detection [For both architecture], spreading requests [For distributed architecture] and returning results [For distributed architecture] via WANET.
[2] Send the information it grabs to the host computer via the terminal network node.
[3] Administrator's electronic device which has privilege can connect to WLAN through the device node and update the database inside. [For distributed architecture]
[4] Can interact with users' portable electronic devices that connect to WLAN through the device node. [For distributed architecture]
[5] Can get important information from external things passively (external things automatically send updated information to the device node) [For both architectures], and make copy into its own database [For distributed architecture] when external things are involved in the WLAN.
[6] Can establish a connection between host computer and the external things. (Host computer can send command to the external things and get feedback) [For centralized architecture]

Each network or device node contains at least one wireless communication module and a high-performance processor, such as an ARM processor, or any appropriate type of processor.

Each network node is installed at significant position for the detecting the location of portable devices and external things in the real world and to provide WLAN access.

Each network node can only communicate with its geographical neighbors (network nodes) via WANET. They can run independently without the host computer, therefore, the internal network is strong, flexible and fast responding. Also, because it is a short-distance communication, this should provide lower costs on wireless modules, lower power consumption, less wireless interference and better communication quality.

A database is running in each network node, and the database stores information that the administrator wants it to be public (that is, can be searched by users). [For distributed architecture]

The Raspberry Pi computer could be a good choice for implementation of the network nodes, since it support Linux system and database, such as MongoDB. [For distributed architecture]

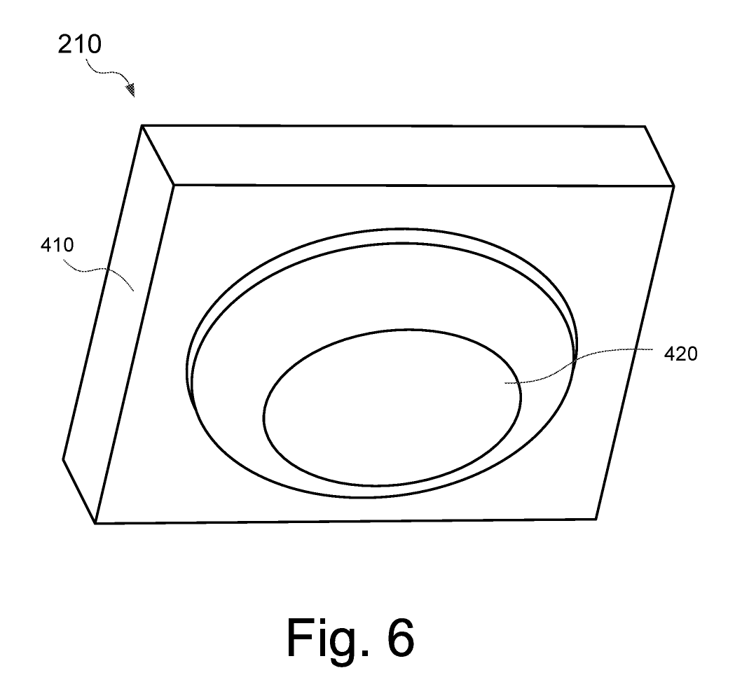

FIG. 6 is an illustration of one embodiment for a form factor for a network node 210 in the system of the present invention. The network node 210 is comprised of a wireless communication module 410, responsible for routing messages along the wireless ad-hoc communications network of the present invention. Network node 210 may also comprise one or more sensors 420, to provide additional environmental data to the system.

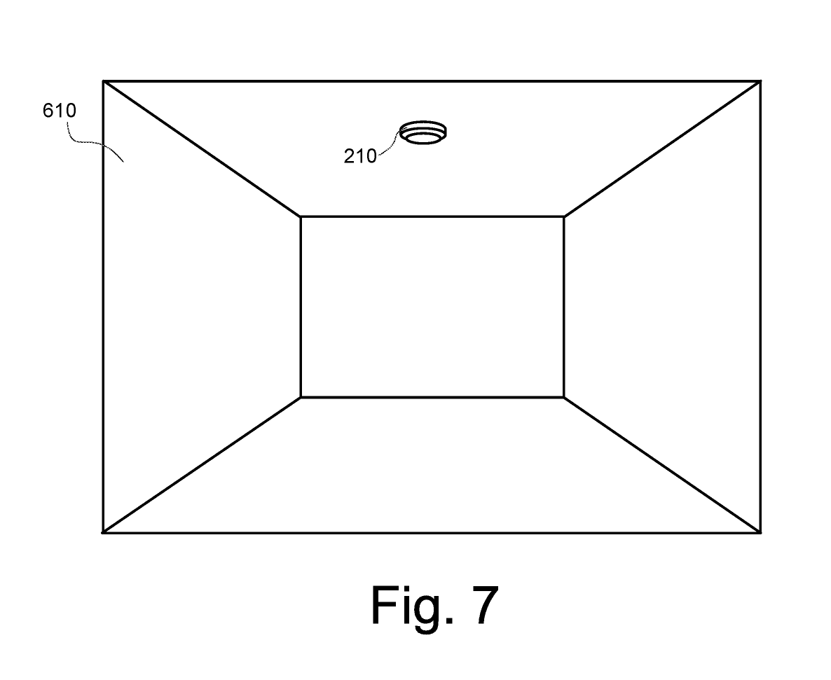

FIG. 7 is an illustration showing one possible placement of a network node 210 of the present invention in a typical room or hallway 610.

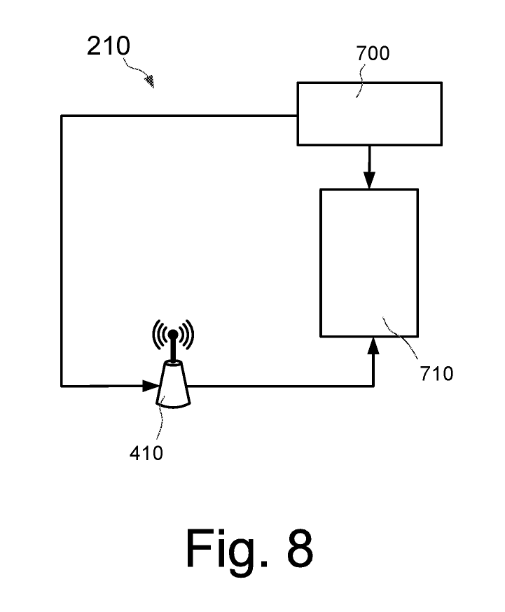

FIG. 8 is a functional block diagram of one embodiment of a network node from the system of the present invention. The network node 210 comprises a power supply 700, a wireless module 410, and a processor 710.

Establishing Geographical Neighbor Communication Mechanisms

The definition of Geographical neighbors: People can walk directly from this node to that node without passing by other nodes (no two device nodes own a common communication channel).

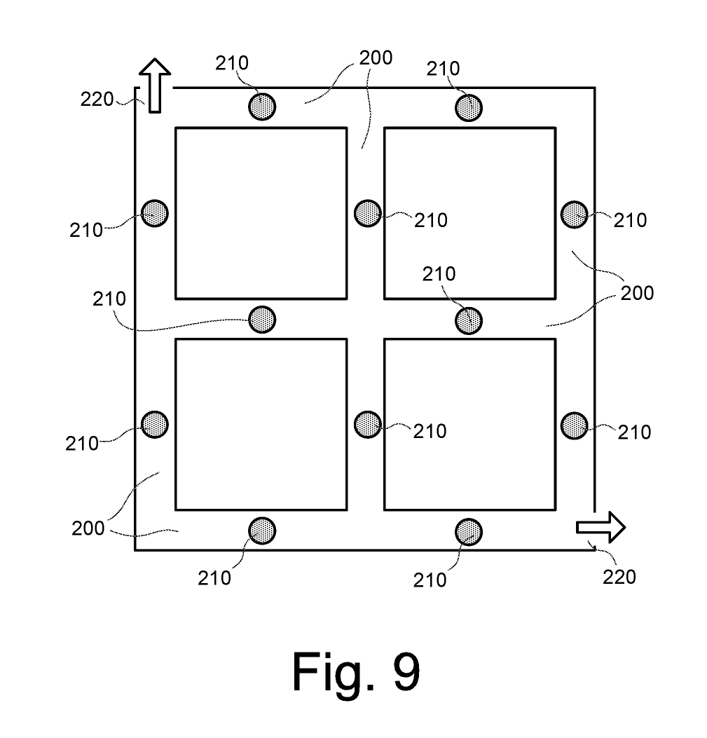

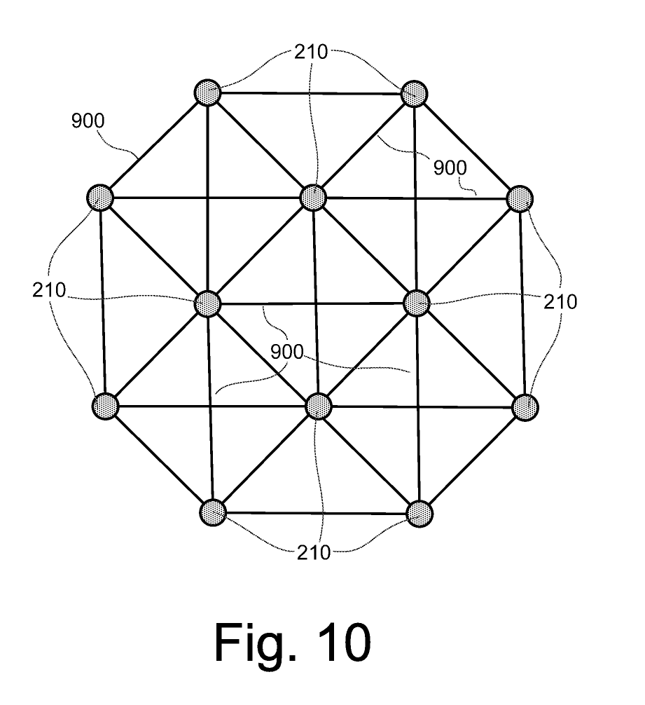

FIG. 9 shows a map of one possible arrangement of device nodes in a building. The map in this figure is similar to the map of FIG. 4B, but tailored to help illustrate the connections of the network in conjunction with FIGS. 10 and 11.

FIG. 9 shows a configuration of hallways 200 and building exits 220. The lines in the figure represent the walls of a building, creating routes or hallways 200, and leading eventually to exits 220. Network nodes 210 are mounted around the building, such as in the hallways 200 or in larger rooms like warehouses. FIGS. 10 and 11 will reference the example arrangement of physical nodes shown in FIG. 9.

FIG. 10 illustrates the actual communication routes between the network nodes 210 of the arrangement of nodes shown in FIG. 9, as they would appear in an ad hoc network. As previously discussed, the network nodes 210 are arranged in an ad hoc network configuration as far as communications goes. In an ad hoc network, every network node 210 can talk with any other network node 210 via wireless communication pathways 900. The arrangement of network nodes 210 in FIG. 10 shows that each network node 210 is communicating with a number of other network nodes 210, representing those within wireless communications distance. Any given node 210 can communicate with any other that is out or wireless range by routing messages through a closer node 210. It is also possible that all of the nodes 210 in the network are able to directly communicate with each other, if the network is physically small enough for wireless, peer-to-peer communications from one node 210 to another.

FIG. 11 illustrates the communication routes between the network nodes of the arrangement of nodes shown in FIG. 9, as they would appear when using a geographical neighbor scheme. It is important to recognize that the network of FIG. 11 is the exact same network of FIG. 10, but only the administrator-defined communication paths 910 are shown in FIG. 11. These defined paths 910 are those paths with map to the physical structure of the building as shown in FIG. 9. Remember, the definition of geographical neighbors is any two nodes 210 where a person can walk from one to the other without passing through other nodes 210. The administrator must define these paths 910 using the terminal software.

Each network node 210 will regularly receive periodic messages from its geographic neighbor nodes as a means of checking on the health of the system. If the periodic message is not received from a neighbor network node 210 within a administrator-defined period of time, the sending node 210 will send a message to a terminal device node 110, reporting the error of that neighbor node 210. Once the sending node 210 begins to again receive periodic messages from the neighbor node 210 again, the sending node 210 will send another message to the terminal device node 110, reporting the recovery of the once faulty neighbor node 210.

FIG. 12 illustrates how network nodes 210 communicating with neighbor nodes 210 can determine and report exceptions in those neighbor nodes 210. Each of Rows 1 through 3 in FIG. 12 represent a different moment in time for each of three neighbor nodes A, B, and C. At Row 1, we see a healthy network, with all nodes both sending and receiving periodic status messages from each other. At the time shown in Row 2, node A has gone silent for some reason, and is no longer sending the periodic messages to node B. Node B, in this situation, would send information to a terminal node 110 that node A is currently offline, possibly routing this information through node C, which is still working in Row 2. Finally, in Row 3, node A is sending messages again, and node B can communicate with a terminal node 110 that the system is working again.

Using the communication scheme introduced in FIG. 12, where nodes communicate periodically with only geographic neighbor nodes, the distributed internet crawler system can determine best routes to desired destinations and communicate this information to a user's portable electronic device.

How Network Node Gets Information from External Things (Automatically)

When external things join the WLAN through the nearest network node, they will keep long-time wireless communication and send the entire information of its dynamic list to that network node. Also, when an external thing's internal dynamic list has changed, it will only send the updated part of information to the network node to update.

External things can use some other method to get more accurate locations which will be important information stored in the database, such as GPS and Ibeacons.

When an external thing breaks the connection between a network node (it might leave the WLAN or switch to a nearer network node which has a stronger signal, but the connection is still maintained), that network node will clear the external thing's information in the database to indicate the external device is not in the area that network node covers anymore.

When an RFID reader breaks the connection between a network node (it might leave the WLAN or switch to a nearer network node which has a stronger signal, but the connection is still maintained), the network node will clear the RFID reader's information in the database, indicating the RFID reader is not in this area anymore, however, the information of external things equipped with RFID chips which have read by this RFID reader will not be cleared, since they are still in the area that network node covers.

When an external thing equipped with an RFID chip enters into or leaves an area, it will be read by a RFID reader (RFID reader can be installed at the entrance or exit of an area), and the RFID reader will read the information of that external thing and that to the related network node so that it will update the information of that external thing, such as adding information and deleting information, in the database via WLAN (Create or Remove information).

The Arrangement of Database

There are two types of database options in this system:
Centralized database, controlled by terminal software in the host computer (It saves all the information from each network node).
Distributed database, controlled by network nodes which are distributed in each network node. (Each network node owns a part of the database which holds the information of things in the area it covers).

Administrators use special client which can either connect to WLAN through the nearest device node or connect to the host computer through the internet to manage these databases with account verification, such as (reading, editing, adding and deleting the information of items) and (reading, editing, adding and deleting the information that user defined to describe the environment's condition, for example, this store is open or not, this store has discount or not).

Databases type: NoSQL can be a good choice (Key+Item). In other words, Tag+information.
(For example, Date [Tag]: 6/3/2015[Information])

FIG. 13 provides examples of possible data constructs which could be read by the RFID reader of the present invention. Each of the three example constructs 1000 has a key or tag 1010 and item information 1020.

The construct for each thing contains the information of the network node that is the entrance for things to join the WLAN.

User Search Mode

1. In Distributed Architecture

When people began to search a keyword with a distance range, either the nearest network node which lets portable devices join WLAN or the network node that the user picks via the internet through the host computer, will compute and get all the network nodes in the distance range (each network node saves the all of the distance information of the other network nodes in the system). That network node will route search request to all the network nodes in the distance range and start a counter for counting how many network nodes have returned the result. When a network node receives this search request, it will perform database matching and calculation (based on the received keyword). After it completes the calculation, it will return relevant content to the original network node which the portable electric device connects via wireless through a correspondence address (point to point). After the original network node receives all of the results from all of the network nodes which receive the search request (the counter is equal to the number of network nodes that receive the search request), it pushes the result to the user's portable device either via WLAN through the nearest device it connects to through or internet though the host computer.

2. In Centralized Architecture

When a user uses a portable device to visit this system, either the nearest network node which let the portable device join the WLAN or the network node that the user picks via the internet through the host computer, the regional map will be downloaded automatically. Then the user needs to select a network node to treat as the original network node. After that, the user can set the geographical searching range and input key word to begin searching. Terminal software in the host computer will compute and get all the network nodes in the distance range (the host computer saves all of the distances between network nodes in the system). Using the above rules (information must belong to network nodes in the searching range) to filter the information. Finally, the result will be returned to the user.

Interconnection Between Things

Each network node is a center for controlling all the “things” in the area it covers and the information associated with those “things.”

Rules packages (similar to scripting language) are used to create interconnections among nodes and the things in and area. More than one rules package can be applied at same time, each rules package can have different privileges.

Several important principles are used in creating the interconnections.
An external thing's location in relation to the network node through which they connect to the WLAN are an important consideration in establishing interconnections.
Each network node is a data router for establishing interconnections. (Each network node can route information to any other node in the system).
Each network node only has privilege to interact with the external things which it covers. (The external things connected to the WLAN through this network node).

The Construction and Mechanics of Rules Packages

Each rules packages contains at least one Event A (for detecting a specific change in the environment) and one Event B (for doing action which might change the environment).

Each Event A and Event B has a unique identifier (ID).

Each Event A is related to a network node. It means Event A is some specific event which happens in the area the network node covers.

Each Event B is related to a network node. It means Event B can only interact with the area that the network node covers.

When the event associated with Event A is detected by the system, Event A will return information, including the ID of Event B, the communication address of the network node to which Event B is related, when it is triggered and which device network it is related to and so on. Then the system will use two of these returns (the ID of Event B, the communication address of the network node that Event B is related to) to confirm and trigger Event B with some parameters (the rest of the returns from Event A will be treated as inputs).

Event B related to each network node that can read and write values from a corresponding global memory that the system allocates for that network node individually.

[For Centralized Architecture]

All global memory is allocated by the terminal software in the host computer.

[For Distributed Architecture]

All the global memory is allocated by the network nodes. (Each network node contains a partial global memory, such that the entire global memory is spread out among all the nodes).

Event A can be either of the following conditions. (Event A does not implement any action, it just returns parameters for the system to trigger event B)

An external thing sends specific updated information to the network node. (An appointed network node is needed).

A user's portable device sends specific parameters to the network node. (An appointed network node is needed).

One network node receives specific parameters from the Internet. (An appointed network node is needed)

One network node triggers Event A by itself when time is reached (timed task, similar to clock). (An appointed network node is needed).

One network node directly updates specific parts of the information in the database. (An appointed network node is needed).

One network node directly disables or enables a special Event A detection which is related to that network node. (An appointed network node is needed).

More actions can be added.

Rule Packages Developer can Program in Event B

Event B has privilege to let the system do the following things:
One network node can directly send parameters to a specific external thing via the interface that external things provide. (This external thing must connects to the WLAN through this network node). (An appointed network node is needed)
One network node can directly send parameters to a portable device that connects to the system through WLAN (this portable device must connects to the WLAN through this network node). (An appointed network node is needed)
One network node can directly send parameters to a portable device that connects to the system through the Internet through the host computer or the WLAN through this network node). (An appointed network node is needed)
One network node can directly send parameters to the Internet. (An appointed network node is needed)
One network node can directly update some specific parts of the information in the database which related to that network node, such as editing, adding and deleting the information of items, editing, adding, and deleting the information that user defined to describe the environment's condition and temporal variable, for example, this store is open or not, this store has discount or not. (An appointed network node is needed)
One network node can directly enable or disable an Event A with a unique ID detection which is related to that network node. (An appointed network node is needed)
One network node can trigger an Event B which can be related to any network node with some parameters (own-defined inputs). (An appointed network node is needed)

More actions can be added.

The system also provides an internal database searching function. This function can return the result from the database when a search rule is used to search the information. The rule can also define the search range to reduce the pressure on the system due to a reduction in the network node's information being matched and paired.

[For Centralized Architecture]

Searching is directly applied on the centralized database in the host computer.

[For Distributed Architecture]

Searching is directly applied on the distributed database which is distributed in each network node. All rules packages are executed by the terminal software in the host computer.

The system includes rules executing engine for detecting event A and executing event B.

[For Centralized Architecture].

All rules packages are executed by the terminal software in the host computer. (Rules executing engine is one component of terminal software.)

[For Distributed Architecture].

All the Event A's and Event B's in all the rules packages are separated into groups. (Each group contains all the events for which the same network node is involved), and each group will be sent to the related network node. Each group is executed by a knowledge engine (rules executor) in each related network node.

### Example: The Detail of a Rule Package

The purpose of this example rules package is providing a friendly, comfortable, and intelligent home environment to a user when they enter the house. This rule package, in one embodiment, may contain the following rules:

Event A:

An infrared sensor beside a specific room's door detects the presence of a human and sends updated information to the system.

Event B(1):

The light sensor in the previous room will be turned on when it receives parameters which includes the location and status of the previous infrared sensor from the system though the interface this light sensor provides.

Event B (2):

The lights in the previous room will be turned on and adjusted to an appropriate brightness when parameters are received which include the location and status of the previous light sensor from the system though the interface this light provides.

Event B(3):

The temperature sensor in the previous room will be turned on when it receives parameters which includes the location and status of the previous infrared sensor from the system though the interface this temperature sensor provides.

Event A:

The temperature sensor in the previous room measures the temperature of the room and send updated information to the system.

Event B(1):

The air-conditioner in the room will be turned on when it receives parameters which includes the location and status of the previous temperature sensor from the system though the interface this air-conditioner provides.

Result:

When a person enters a specific room, both lights and air-conditioner in this room will be adjusted to appropriate status to ensure person's comfort.

Using Global Memory to Realize Special Logic

And

(Goal):

Both one Event A (related to network node A) and another Event A (related to network node B) happen, and trigger one Event B to do some actions (related to network node C)

(Program)

Both one event A (related to network node A) and another event A (related to network node B) happens will trigger one event B (related to network node C). In event B (related to network node C), it will save information of the time that each event A triggered this event B into global memory. Then, it will read all the previous information of any event A which related to network node A or network node B in the global memory, and compare. If the time interval is small, which means both one event A (related to network node A) and another event A (related to network node B) happened, then event B will do some action. Otherwise, do nothing.

Or

(Goal):

Either one event A (related to network node A) or another event A (related to network node B) happens will trigger one event B (related to network node C)

(Program)

Both one event A (related to network node A) and another event A (related to network node B) happens and trigger one event B (related to network node C). In event B (related to dev network ice node C), it will save information of the time that event A triggered this event B into the global memory. Then it will read all the previous information of any event A which related to network node A or network node B in the global memory, and compare. If the time interval is small, which means both one event A (related to network node A) and another event A (related to network node B) happened, then event B will not do some action, otherwise it will.

How to Apply Rules Packages on Distributed Architecture

There is a rules executor (or knowledge engine) in each network node. When the terminal software in the host computer downloads the rules packages from the remote servers, it will reconstruct and separate all the rules packages into different groups which can be divided into two categories, Event A and Event B. Each group will be sent to the related network node. And each network node will index all the event A's in a special order which can improve the performance of triggering detection. When an event A is detected by a network node, event A will return information which includes the ID of event B, the communication address of the network node to which event B is related, when it is triggered and which network node it is related to and so on. Then, this network node will use two of these returns (the ID of event B, the communication address of the network node that event B is related to) to confirm the network node that event B is related to, after that, triggers a request to be sent to that network node, and that network node will execute event B with some parameters (the rest returns from event A will be treated as inputs).

FIG. 14 is an illustration of an example of system use, where a light is controlled from a mobile device from a separate room. This figure shows the example of controlling a remote light through a cell phone when the cell phone is in a specific room.

The figure shows network node A 110A in one area of the house, and network node B 110B in another area of the house. A personal device (cell phone) 130 is located near node A 110A and a light 122 is located near node B 110B.

Event A (ID: 100) related to the network node A 110A.
The cell phone send some parameters to network node A 110A, which includes the communication address of network node B 110B, the ID of light 122 and the “ON” command. This Event A is triggered which returns the communication address of network node B, the ID of light 122 and the “ON” command to this network node.

After network node A 110A gets the return of event A, this network node 110A uses and routes the returns to network node B 110B (sending Signal AB).

Event B1 (ID: 200) related to the network node B 110B.
Event B1 contains several steps.
(1) It receives the information that network node A 110A routed (Signal AB).
(2) Uses ID of light 122 to identify the special light.
(3) Sends “ON” command to that special light 122.
(4) Network node B 110B routes the successful information to the device node A 110A, which includes the communication address of device node A 110A, and the ID of cell phone 130.

Network node B 110B routes the information (Signal BA) to network node A 110A, which includes the communication address of network node A 110A, and the ID of cell phone 130.

Event B2 (ID: 300) related to network node 110B.
Event B2 contains several steps.
(1) It receives the information that network node B 110B routed (Signal BA).
(2) Using the ID of cell phone 130 to identify the cell phone.
(3) Push the rest of the information to cell phone 130.

FIG. 15 is an illustration of another example of system use, where a sprinkler system can be controlled based on sensors located at a remote (separate) location. Specifically, this example relates to watering a garden at 3:00 p.m. every day except rainy days.

The figure shows network node A 110A in one outdoor location, and network node B 110B in another outdoor location. A personal device (cell phone) 130 is located near node A 110A and a sprinkler 136 is located near node B 110B.

Event A1 (ID: 100) related to the network node A
The rain sensor 134 detects rain, and then sends specific information to the device node A 110A. Then, event A1 is triggered which returns the communication address of device node B 110B, and the ID of an event B.

Event A2 (ID: 200) related to the device node A
The rain sensor detects the rain stopping, and then sends specific information to the device node A 110A. Then, event A2 is triggered which returns the communication address of network node B, and the ID of an event B2.

After network node A 110A gets the returns of event A1 (ID: 100), this network node routes the returns (Signal AB1) to device node B 110B.

After network node A 110A get the returns of event A2 (ID: 200), this device node routes the returns (Signal AB2) to device node B 110B.

Event B1 (ID: 300) related to the network node 110B.
Event B1 contains one step.
(1) Let network node B 110B stop detecting event A

Event B2 (ID: 400) related to the network node 110B.
Event B2 contains one step.
(1) Let network node B 110B start detecting event A3 (ID: 500)

Event A3 (ID: 500) related to the network node B 110B.
The internal timer in the network node B 110B reaches 3:00 p.m. Then, this event A3 is triggered which returns the communication address of device node B 110B, and the ID of an event B3.

After device node B 110B get the returns of event A3 (ID: 500), this network node routes the returns to device node B 110B.

Event B3 (ID: 600) related to the network node B.
Event B3 contains one step.
(1) Send some parameter to the sprinkler 136 which will turn on sprayer for a specified time.

How to Apply Rules Packages on Centralized Architecture

There is a rules executor (knowledge engine) in the terminal software. It executes all the rules packages. It will index all the event A's in all the rules packages in a special order which can improve the performance of triggering detection. When an event A is detected by the system (all the network nodes will send updated information to the host computer), event A will return information which includes the ID of event B, the communication address of the network node to which event B is related, when it is triggered and which network node it is related and so on. Then, the system will use two of these returns (the ID of event B, the communication address of the network node that event B is related to) to confirm and trigger event B with parameters (the rest of the returns from event A will be treated as inputs). Event B is executed by the executor in the terminal software.

Client Software in Portable Device Node [Search Bar+History+Bookmarks+Feedback Display+Routes Indication]

Search Bar and Other Functions: When users want to search, the client will display a search interface which is similar to that of a standard search engine, such as that used by Google, Bing, Amazon, and so on. It will recommend popular search terms (the information for popular search terms can come from the remote servers, since they can collect and analyze lots of information to understand the users' needs.) In addition to the search bar functionality, the client software could offer Search History, Bookmarks, and a Feedback Display.

User Location Indication

When a portable device connects to the system via the WLAN, the location of the network node the user connects to in order to access the WLAN is assumed to be the location of the user. The application will display a user's location based on that network node's location.

FIG. 16 illustrates one embodiment of a map that could appear on a user's portable device to show the user's location in relation to other things in the system. An icon of the user 1035 is shown on a two-dimensional or three-dimensional map. The locations of services (such as stores, restaurants, restrooms, etc.) can be shown with special markers 1030. Rooms (for instance, stores in a mall) 1040 can be shown along with common areas 1045 (such as food courts, fountain areas, hallways, etc.)

Remote Servers

Since information is only stored in the local area, it is difficult to realize tran-regional searching function and other functions, for many reasons, such as network speed, a large number of visits to the site, etc. It may be necessary to save some important information (not all the information, just the critical elements) on the remote servers which can suffer extremely heavy dispatch load and high concurrent connection count. After the user finishes trans-regional searching via the remote servers, they can pick the region in which they want to do more detailed searching and other actions.

Remote servers support the information of the products uploading and storing from their manufacturers.

Remote servers supports the information of the products downloading by different systems that distributed in different areas when unknown products (devices) connects to the system at the first time.

Applications

Finally, the following sections list several example uses or applications for the present invention.

Digital stores. The user can search for the locations of discounts, foods, news, etc., in the store.

Teaching building. Check the occupancy of classrooms (whether class is running) and office (whether professor is available).

Fully automated factor. Machines use this system to locate its position, the locations of products, and to optimize the assembly line.

Parking. Finding where a person's car is located in a large parking lot. (Car is an external thing which can join the external network).

Tourist attractions. Finding interesting places, getting directions, downloading their history, etc.

Library. Finding a textbook, resources, available rooms for study, etc.

Exhibitions. Finding things, the locations of events, etc., also check their information.

Office. Finding things in an office, the locations of files, etc., also check their information.

Road. Getting real-time state of traffic.

It should be obvious to one skilled in the art that the present invention could be applied in numerous applications other than those listed herein.

What is claimed:

1. A distributed search and database system, comprising:
a central computer;
a plurality of network nodes, wherein each network node comprises a wireless communication module;
a computer program;
application software; and
a plurality of personal electronic devices,
wherein the plurality of network nodes form a wireless communications network with each other, wherein a subset of the plurality of network nodes are connected via a direct connection to the central computer; wherein the computer program executes on the central computer, wherein the computer program is used to configure the wireless communications network, wherein the central computer communicates configuration information via the hardwired connection to the subset of the plurality of network nodes, wherein the subset of the plurality of network nodes distributes the configuration information to all network nodes via the wireless communications network, wherein each of the network nodes in the plurality of network nodes in the wireless communications network is capable of communicating with a plurality of external intelligent items, obtaining information from the plurality of external intelligent items, managing the information in a database, and providing the information on request to the plurality of personal electronic devices for display to a user.

2. The distributed search and database system of claim 1, wherein the wireless communications network is an ad hoc communications network.

3. The distributed search and database system of claim 1 of claim 1, wherein the direct connection is a hardwired connection.

4. The distributed search and database system of claim 1, wherein the direct connection is a wireless connection.
